(19) United States
(12) Patent Application Publication
(10) Pub. No.: US 2022/0015985 A1
(43) Pub. Date: Jan. 20, 2022

(54) Spinal Adjustment Apparatus

(71) Applicant: Wayne L. Potesak, Las Vegas, NV (US)

(72) Inventor: Wayne L. Potesak, Las Vegas, NV (US)

(21) Appl. No.: 16/929,972

(22) Filed: Jul. 15, 2020

(51) Int. Cl. A61H 15/00

(52) U.S. Cl. CPC A61H 15/0092; A61H 2201/1253; A61H 2015/005; A61H 2205/081

(57) ABSTRACT

A spinal adjustment apparatus for providing an easy, adjustable tool for at home back pain relief includes a rod having a rod first end and a rod second end. A pair of massage balls is coupled to the rod. Each massage ball has an attachment aperture extending through an axis thereof. The rod is coupled through the attachment aperture of each massage ball such that each massage ball may be adjustably positioned along the rod between the rod first end and the rod second end. A pair of handles is coupled to the rod. The pair of handles is coupled to the rod first end and the rod second end.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to spinal adjustment tools and more particularly pertains to a new spinal adjustment tool for providing an easy, adjustable tool for at home back pain relief.

### (2) Description of Related Art Including Information Disclosed Under 37 CFR 1.97 and 1.98

The prior art relates to spinal adjustment tools. Existing tools may employ rollers or balls to create pressure, but do not allow for easy adjustment between pressure points. Existing devices also lack interchangeable balls to allow for different sizes to be used.

### BRIEF SUMMARY OF THE INVENTION

An embodiment of the disclosure meets the needs presented above by generally comprising a rod having a rod first end and a rod second end. A pair of massage balls is coupled to the rod. Each massage ball has an attachment aperture extending through an axis thereof. The rod is coupled through the attachment aperture of each massage ball such that each massage ball may be adjustably positioned along the rod between the rod first end and the rod second end. A pair of handles is coupled to the rod. The pair of handles is coupled to the rod first end and the rod second end.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a spinal adjustment apparatus according to an embodiment of the disclosure.

FIG. 2 is an isometric view of an embodiment of the disclosure.

FIG. 3 is a front elevation view of an embodiment of the disclosure.

FIG. 4 is an isometric exploded view of an embodiment of the disclosure.

FIG. 5 is a side elevation view of an embodiment of the disclosure.

FIG. 6 is a cross-sectional view of an embodiment of the disclosure along the line 6-6 of FIG. 3.

FIG. 7 is an in-use view of an embodiment of the disclosure.

### DETAILED DESCRIPTION OF THE INVENTION

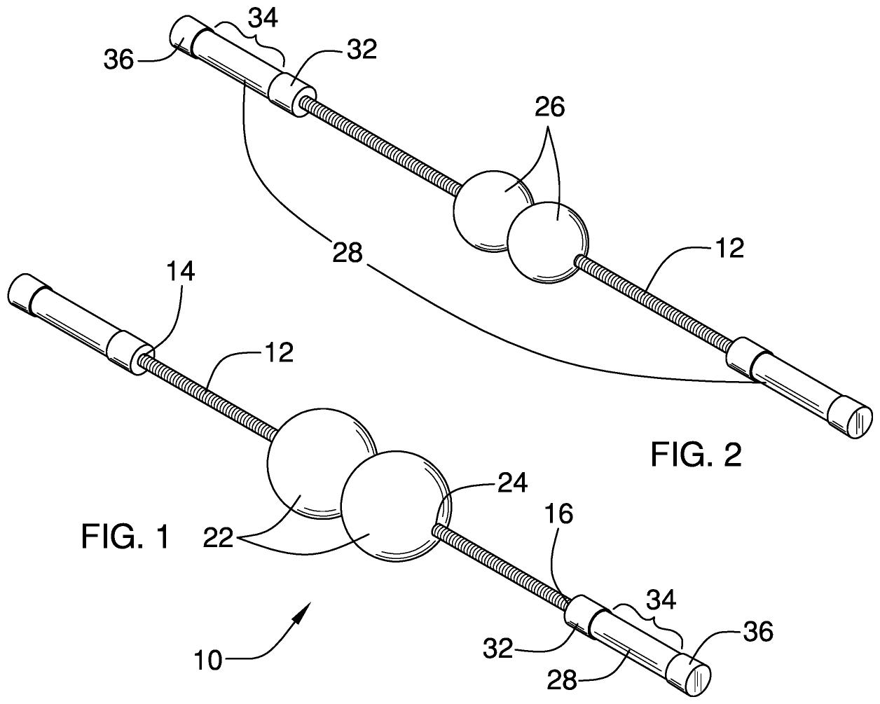

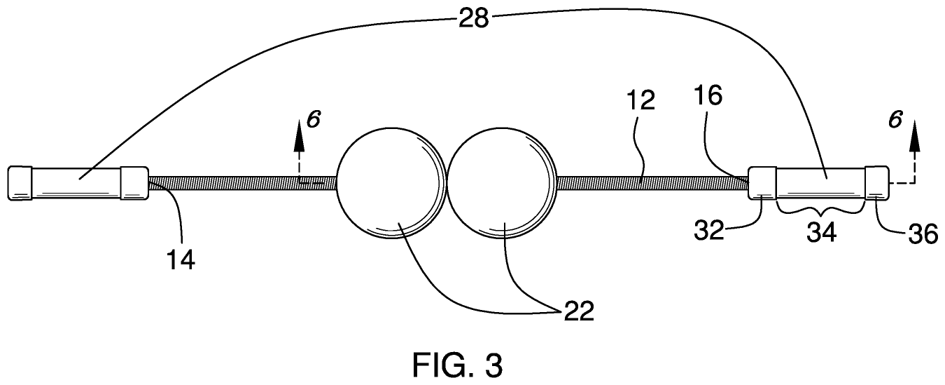

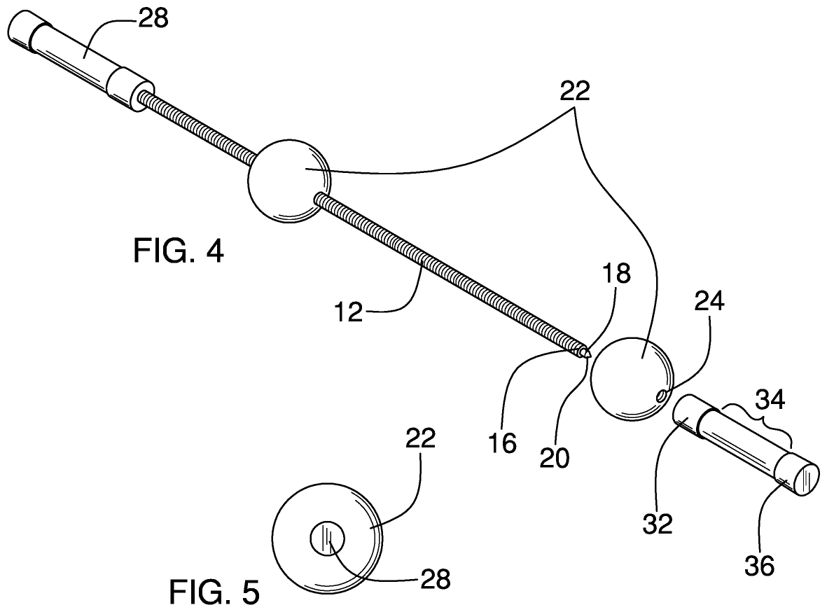

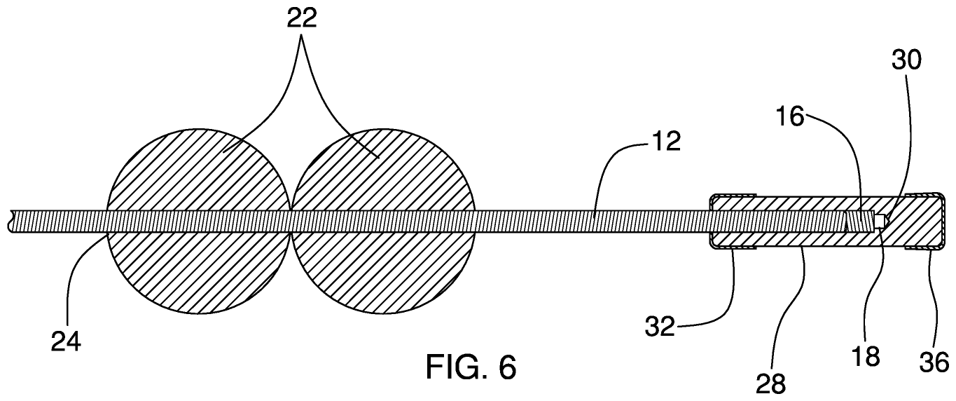

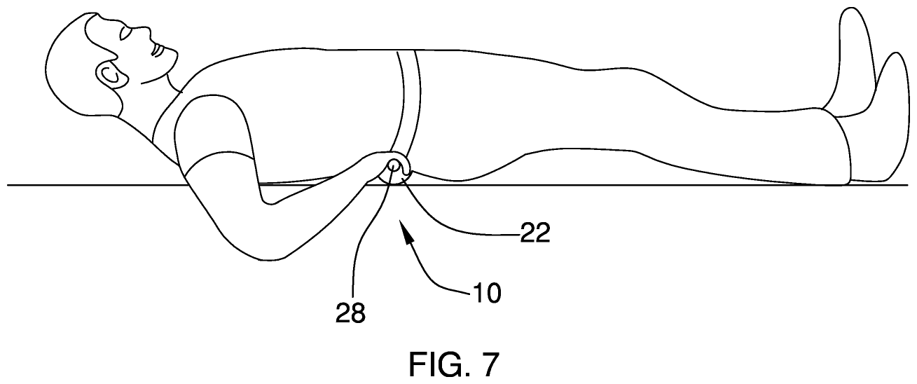

With reference now to the drawings, and in particular to FIGS. 1 through 7 thereof, a new spinal adjustment tool embodying the principles and concepts of an embodiment of the disclosure and generally designated by the reference numeral 10 will be described.

As best illustrated in FIGS. 1 through 7, the spinal adjustment apparatus 10 generally comprises a rod 12 having a rod first end 14 and a rod second end 16. The rod 12 may be threaded with the rod first end 14 and the rod second end 16 having an unthreaded engagement portion 18. The engagement portion 18 is thinner and has a pointed end 20. The rod 12 may have a length of 24″ and a diameter of ⅜″.

A pair of massage balls 22 is coupled to the rod 12. Each massage ball 22 has a threaded attachment aperture 24 extending through an axis thereof. The rod 12 is threadably engaged through the attachment aperture 24 of each massage ball such that each massage ball 22 may be adjustably positioned along the rod 12 between the rod first end 14 and the rod second end 16. The pair of massage balls 22 may be positioned adjacent one another and medially between the rod first end 14 and the rod second end 16, or they may be spaced apart. Each massage ball 22 may have a diameter equal to ⅙th of the length of the rod 12 or 4″.

There may be a pair of secondary massage balls 26. The pair of secondary massage balls 26 is smaller than the pair of massage balls 22 and is interchangeable on the rod 12 to be used when desired. Each secondary massage ball 26 may have a diameter equal to ⅛th of the length of the rod 12 or 3″. Each massage ball 22 and each secondary massage ball 26 may be a rubberized or plasticized to provide a desired amount of elastic deformation under a user's bodyweight.

A pair of handles 28 is coupled to the rod 12. Each handle 28 of the pair of handles has a threaded handle aperture 30 to selectively engage the rod first end 14 and the rod second end 16. The unthreaded engagement portion 18 allows for easier alignment of the rod 12 and prevents undesired disengagement. Each handle 28 may have an inner cap portion 32, a medial grip portion 34, and an outer cap portion 36 to for comfort and slip resistance.

In use, the pair of massage balls 22 or the pair of secondary massage balls 26 is threaded onto the rod 12 into the desired position. The user then lies on top of the apparatus 10 to create pressure with his or her bodyweight with the pair of massage balls 22 centered on the spine. The user then secures the pair of handles 28 to slowly move the apparatus 10 along the spine in small increments to relieve pain and pressure while properly aligning the vertebrae.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A spinal adjustment apparatus comprising:
a rod having a rod first end and a rod second end;
a pair of massage balls coupled to the rod, each massage ball having an attachment aperture extending through an axis thereof, the rod being coupled through the attachment aperture of each massage ball such that each massage ball may be adjustably positioned along the rod between the rod first end and the rod second end; and
a pair of handles coupled to the rod, the pair of handles being coupled to the rod first end and the rod second end.

2. The spinal adjustment apparatus of claim 1 further comprising the rod being threaded; the attachment aperture of each massage ball being threaded; each handle of the pair of handles having a threaded handle aperture to selectively engage the rod.

3. The spinal adjustment apparatus of claim 1 further comprising each of the rod first end and the rod second end having an unthreaded engagement portion, the engagement portion being thinner and having a pointed end.

4. The spinal adjustment apparatus of claim 1 further comprising a diameter of each massage ball being between ⅛^{th} and ⅙^{th} of a length of the rod.

5. The spinal adjustment apparatus of claim 1 further comprising each handle having an inner cap portion, a medial grip portion, and an outer cap portion.

6. The spinal adjustment apparatus of claim 1 further comprising a pair of secondary massage balls, the pair of secondary massage balls being smaller than the pair of massage balls and being interchangeable on the rod.

7. A spinal adjustment apparatus comprising:
a rod having a rod first end and a rod second end, the rod being threaded, the rod first end and the rod second end having an unthreaded engagement portion, the engagement portion being thinner and having a pointed end;
a pair of massage balls coupled to the rod, each massage ball having a threaded attachment aperture extending through an axis thereof, the rod being threadably engaged through the attachment aperture of each massage ball such that each massage ball may be adjustably positioned along the rod between the rod first end and the rod second end, each massage ball having a diameter equal to ⅙^{th} of a length of the rod;
a pair of secondary massage balls, the pair of secondary massage balls being smaller than the pair of massage balls and being interchangeable on the rod, each secondary massage ball having a diameter equal to ⅛^{th} of the length of the rod; and
a pair of handles coupled to the rod, each handle of the pair of handles having a threaded handle aperture to selectively engage the rod first end and the rod second end, each handle having an inner cap portion, a medial grip portion, and an outer cap portion.
